(19) United States
(12) Patent Application Publication
(10) Pub. No.: US 2022/0221699 A1
(43) Pub. Date: Jul. 14, 2022

(54) DOUBLE-TELECENTRIC PROJECTION LENS AND HEAD-UP DISPLAY DEVICE MOUNTED ON AUTOMOBILE

(71) Applicant: IVIEW DISPLAYS (SHENZHEN) COMPANY LTD., Shenzhen (CN)

(72) Inventors: Jiuwei Liang, Shenzhen (CN); Weizhan Zhu, Shenzhen (CN); Mingnei Ding, Shenzhen (CN); Steve Yeung, Hong Kong (CN); Zhiqiang Gao, Hong Kong (CN)

(21) Appl. No.: 17/546,141

(22) Filed: Dec. 9, 2021

Related U.S. Application Data
(63) Continuation of application No. PCT/CN2021/083379, filed on Mar. 26, 2021.

(30) Foreign Application Priority Data
Jan. 8, 2021 (CN) 202110022840.8

(51) Int. Cl. G02B 13/22; G02B 27/01; G02B 26/08

(52) U.S. Cl. CPC G02B 13/22; G02B 26/0833; G02B 27/0101

(57) ABSTRACT

The present application provides a double-telecentric projection lens. The double-telecentric projection lens includes a front lens group, a rear lens group, and an equivalent prism that are successively arranged between an image side and a DMD chip; wherein the front lens group includes a first lens, a second lens, a third lens, a fourth lens, and a fifth lens that are successively arranged, and the rear lens group includes a sixth lens, a seventh lens, an eighth lens, and a ninth lens that are successively arranged, wherein the third lens and the fourth lens constitute a double-cemented lens; and the DMD chip is configured to simultaneously emit two images, wherein during simultaneous emission of the two images from the DMD chip, the simultaneously emitted two images are emitted from the double-telecentric projection lens and imaged at different positions.

### CROSS-REFERENCE TO RELATED APPLICATION

This application is based upon and claims priority to Chinese Patent Application No. 202110022840.8, filed before China National Intellectual Property Administration on Jan. 8, 2021 and entitled “DOUBLE-TELECENTRIC PROJECTION LENS AND HEAD-UP DISPLAY DEVICE MOUNTED ON AUTOMOBILE,” the entire contents of which are incorporated herein by reference.

### TECHNICAL FIELD

Embodiments of the present disclosure relate to the technical field of projection optics, and in particular, relate to a double-telecentric projection lens and a head-up display device mounted on an automobile.

### BACKGROUND

A head-up display (HUD) refers to a display mounted on a front windshield of an automobile. Nowadays, with transformation of the automobile towards intelligence, at present, newly designed intelligent automobiles are all mounted with HUDs, and drivers are capable of knowing speed, speed limitation signs, drive routes and the like vehicle information and road condition information with no need of lowering heads to check instrument panels. Augmented reality HUDs (AR HUDs) are prevailing currently. An AR HUD is a head-up display device capable of displaying AR pictures.

During practice of embodiments of the present disclosure, the applicant has found that the related art has at least the following problem: At present, the HUD, that is, the head-up display device, mounted on the automobile is only capable of displaying a two-dimensional planar picture, for example, a driving information picture of the automobile, or is only capable of displaying an AR picture, for example, a picture displaying road condition information captured by a camera of the automobile. Where these two pictures need to be simultaneously displayed, two head-up display devices are needed.

The embodiments of the present disclosure are intended to provide a projection optical system and a head-up display device mounted on an automobile, such that projection imaging of two pictures is achieved. To achieve this solution, a double-telecentric projection lens is designed in the embodiments of the present disclosure to achieve imaging by a single optical engine (single DMD chip) in combination with double optical lenses. In this way, a projection solution capable of achieving projection imaging of two pictures in the above solution is achieved.

### SUMMARY

With respect to the defects in the related art, objects of embodiments of the present disclosure are to provide a double-telecentric projection lens, and a head-up display device mounted on an automobile.

The objects of the embodiments of the present disclosure are achieved by employing the following technical solutions:

To solve the above technical problem, in a first aspect, the embodiments of the present disclosure provide a double-telecentric projection lens applicable to a projection optical system in a head-up display device mounted on an automobile. The double-telecentric projection lens includes a front lens group, a rear lens group, and an equivalent prism that are successively arranged between an image side and a DMD chip; wherein

the front lens group includes a first lens, a second lens, a third lens, a fourth lens, and a fifth lens that are successively arranged, and the rear lens group includes a sixth lens, a seventh lens, an eighth lens, and a ninth lens that are successively arranged, wherein the third lens and the fourth lens constitute a double-cemented lens; and

the DMD chip is configured to simultaneously emit two images, wherein during simultaneous emission of the two images from the DMD chip, the simultaneously emitted two images are emitted from the double-telecentric projection lens and imaged at different positions.

In some embodiments, an image side of the first lens is a concave surface, and an object side of the first lens is a convex surface;

an image side of the second lens is a convex surface, and an object side of the second lens is a convex surface;

an image side of the third lens is a concave surface, and an object side of the third lens is a concave surface;

an image side of the fourth lens is a convex surface, and an object side of the fourth lens is a convex surface;

an image side of the fifth lens is a convex surface, and an object side of the fifth lens is a convex surface;

an image side of the sixth lens is a concave surface, and an object side of the sixth lens is a concave surface;

an image side of the seventh lens is a concave surface, and an object side of the seventh lens is a convex surface;

an image side of the eighth lens is a convex surface, and an object side of the eighth lens is a convex surface; and

an image side of the ninth lens is a convex surface, and an object side of the ninth lens is a concave surface.

In some embodiments, the equivalent prism is a turning prism and a right-angle triangular prism, wherein one right-angle surface of the right-angle triangular prism is opposite to a light exit surface of the DMD chip, the other right-angle surface of the right-angle triangular prism is opposite to a light incident side of the rear lens group, and an inclined surface of the right-angle triangular prism has a reflection angle of 90 degrees; and

an optical axis of the DMD chip is perpendicular to an optical axis of the front lens group and the rear lens group.

In some embodiments, the double-telecentric projection lens has a focal length of 90 mm, and the double-telecentric projection lens has a total length of 150 mm.

In some embodiments, the double-telecentric projection lens has a magnification of 1:1, and the double-telecentric projection lens has a relative aperture of 2.

To solve the above technical problem, in a second aspect, the embodiments of the present disclosure provide a head-up display device mounted on an automobile. The head-up display device includes a projection optical system capable of projecting a first image and a second image on a front windshield of the automobile such that imaging is achieved on the front windshield, wherein the projection optical system includes:

the double-telecentric projection lens according to the first aspect, wherein the double-telecentric projection lens is configured to simultaneously emit light beams of the first image and the second image; and

a light splitting device, wherein an optical center of the light splitting device is arranged on an image side of the double-telecentric projection lens, and a light incident side of the light splitting device is arranged to face a light exit side of the double-telecentric projection lens;

a first reflection unit, wherein a light incident side of the first reflection unit is arranged to face a first light reflection side of the light splitting device;

a first lens, wherein a light incident side of the first lens is arranged to face a light reflection side of the first reflection unit, and a light exit side of the first lens is configured to emit the first image;

a second reflection unit, wherein a light incident side of the second reflection unit is arranged to face a second light reflection side of the light splitting device; and

a second lens, wherein a light incident side of the second lens is arranged to face a light reflection side of the second reflection unit, and a light exit side of the second lens is configured to emit the second image.

In some embodiments, the light splitting device includes a first reflection structure and a second reflection structure; wherein the first reflection structure is configured to receive and reflect the light beam of the first image, the second reflection structure is configured to receive and reflect the light beam of the second image, a light reflection side of the first reflection structure is the first light reflection side of the light splitting device, and a light reflection side of the second reflection structure is the second light reflection side of the light splitting device.

In some embodiments, the first reflection structure and the second reflection structure are both a mirror.

In some embodiments, the first reflection structure and the second reflection structure are both a combination of a mirror, and a filter, a highly reflective film and/or an anti-reflection lens.

In some embodiments, the first reflection unit and the second reflection unit are both a mirror.

As compared with the related art, the present disclosure achieves the following beneficial effects: The embodiments of the present disclosure provide a double-telecentric projection lens. The double-telecentric projection lens includes a front lens group, a rear lens group, and an equivalent prism that are successively arranged between an image side and a DMD chip; wherein the front lens group includes a first lens, a second lens, a third lens, a fourth lens, and a fifth lens that are successively arranged, and the rear lens group includes a sixth lens, a seventh lens, an eighth lens, and a ninth lens that are successively arranged, wherein the third lens and the fourth lens constitute a double-cemented lens; and the DMD chip is configured to simultaneously emit two images, wherein during simultaneous emission of the two images from the DMD chip, the simultaneously emitted two images are emitted from the double-telecentric projection lens and imaged at different positions. The double-telecentric projection lens according to the embodiments of the present disclosure is applicable to the projection optical system in the head-up display device mounted on an automobile such that simultaneous projection imaging of two pictures is achieved, and the imaging effect is good.

### BRIEF DESCRIPTION OF THE DRAWINGS

One or more embodiments are illustrated by way of example, and not by limitation, in the figures of the accompanying drawings, wherein elements/modules having the same reference numeral designations represent like elements/modules throughout. The drawings are not to scale, unless otherwise disclosed.

FIG. 1 is a schematic diagram of an application scenario of a double-telecentric projection lens according to an embodiment of the present disclosure;

FIG. 2 is a schematic diagram of imaging on a front windshield in the application scenario in FIG. 1;

FIG. 3 is a schematic diagram of an optical path of a double-telecentric projection lens according to a first embodiment of the present disclosure;

FIG. 4 is a schematic diagram of a partial structure of the double-telecentric projection lens in FIG. 3;

FIG. 5 is a schematic diagram of a partial structure of a double-telecentric projection lens according to the first embodiment of the present disclosure;

FIG. 6 is a schematic diagram of full field transfer function (MTF) values of the double-telecentric projection lens in FIG. 3;

FIG. 7 is a schematic diagram of field curvature and distortion of a full field and full wave-band of the double-telecentric projection lens in FIG. 3;

FIG. 8 is a schematic diagram of vertical chromatic aberration of a full field and full wave-band of the double-telecentric projection lens in FIG. 3;

FIG. 9 is a schematic diagram of dot columns of a full field of the double-telecentric projection lens in FIG. 3;

FIG. 10 is a schematic diagram of hardware structure of a head-up display device mounted on an automobile according to a second embodiment of the present disclosure; and

FIG. 11 is a schematic structural diagram of an optical path of a projection optical system in the head-up display device mounted on an automobile in FIG. 10.

### DETAILED DESCRIPTION

The present disclosure is further described with reference to some exemplary embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure.

For clearer descriptions of the objectives, technical solutions, and advantages of the present disclosure, the present disclosure is further described with reference to specific embodiments and attached drawings. It should be understood that the specific embodiments described herein are only intended to explain the present disclosure instead of limiting the present disclosure.

It should be noted that, in the absence of conflict, embodiments of the present disclosure and features in the embodiments may be incorporated, which all fall within the protection scope of the present disclosure. In addition, although function module division is illustrated in the schematic diagrams of apparatuses, and in some occasions, module division different from the divisions of the modules in the apparatuses may be used. Further, the terms “first,” “second,” and the like used in this text do not limit data and execution sequences, and are intended to distinguish identical items or similar items having substantially the same functions and effects.

For ease of definition of the connection structure, positions of the components are defined using a light exit direction of a light beam as a reference. As used herein, the terms “upper,” “lower,” “left,” “right,” “vertical” “horizontal,” and the like expressions are used for illustration purposes only. For ease of definition of the connection structure, positions of the components are defined using a light exit direction of a light beam as a reference.

Unless the context clearly requires otherwise, throughout the specification and the claims, technical and scientific terms used herein denote the meaning as commonly understood by a person skilled in the art. Additionally, the terms used in the specification of the present disclosure are merely for description of the embodiments of the present disclosure, but are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

In view of the case where the conventional head-up display device mounted on an automobile is only capable of displaying an image, but incapable of simultaneously displaying a close-up image and a distal image, and/or the case a two-dimensional image and a three-dimensional image need to be simultaneously displayed, embodiments of the present disclosure provide a double-telecentric projection lens. In the double-telecentric projection lens, a DMD chip is configured to simultaneously emit two images, wherein during simultaneous emission of the two images from the DMD chip, the simultaneously emitted two images are emitted from the double-telecentric projection lens and imaged at different positions. In this way, different contents and pictures are respectively displayed at two different positions. In addition, the double-telecentric projection lens according to the embodiments of the present disclosure has advantages of good imaging effect and small size.

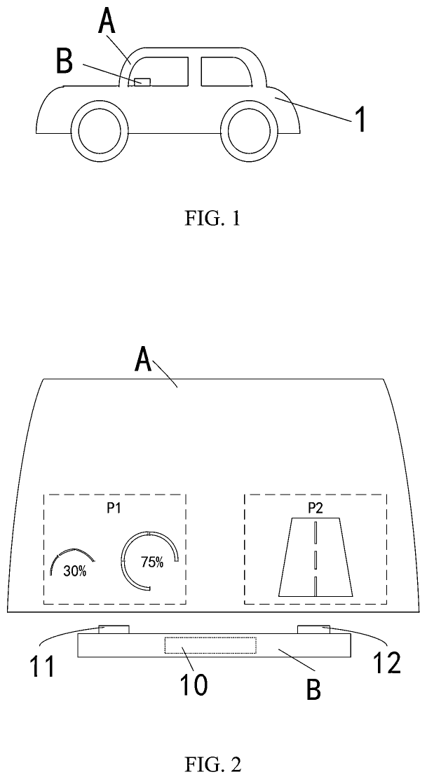

FIG. 1 is a schematic diagram of an application scenario of a double-telecentric projection lens according to an embodiment of the present disclosure, and FIG. 2 is a schematic diagram of imaging on a front windshield in the application scenario in FIG. 1. The application scenario involves an automobile 1. The automobile 1 includes a front windshield A and a head-up display device B.

A projection optical system 10 in the head-up display device B employs a double-telecentric projection lens 100 according to the embodiment of the present disclosure to achieve imaging and display of two image pictures. Light beams of a first image P1 and a second image P2 output by the double-telecentric projection lens 100 are capable of outputting the first image P1 and the second image P2 through a first lens 11 and a second lens 12 respectively in the projection optical system 10.

In this application scenario, the first image P1 is mainly configured to display a two-dimensional image, for example, driving information of the automobile 1, wherein the driving information includes, but is not limited to, speed information, oil supply information, and the like of the automobile 1. Accordingly, the automobile 1 should be equipped with a speed sensor, an oil supply sensor, and the like. Specifically, configurations of the two-dimensional image, the driving information of the automobile 1, and the corresponding sensor may be selected according to the actual needs, which are not limited to those in the application scenario of the present disclosure.

In this application scenario, the second image P2 is mainly configured to display a three-dimensional image, that is, an AR picture, for example, road condition information of a road where the automobile 1 is traveling, wherein the road condition information includes, but is not limited to, lanes, road lines, pedestrian crossings, obstacles, traffic lights, traffic sign boards, and the like. Accordingly, the automobile 1 should be equipped with a camera, a laser radar, and the like detection device. Further, where the automobile 1 is capable of implementing a navigation function, navigation indication information may also be over-displayed together with the road condition information. Specifically, configurations of the three-dimensional image, the road condition information of the road where the automobile 1 is traveling, and the corresponding detection device may be selected according to the actual needs, which are not limited to those in the application scenario of the present disclosure.

In this application scenario, the front windshield A is preferably made of a glass material that is capable of clearly achieving imaging and has a good light transmittance. Specifically, the material may be selected according to the actual needs, which is not limited to that in the application scenario of the present disclosure.

Hereinafter, the embodiments of the present disclosure are further illustrated with reference to the accompanying drawings.

### First Embodiment

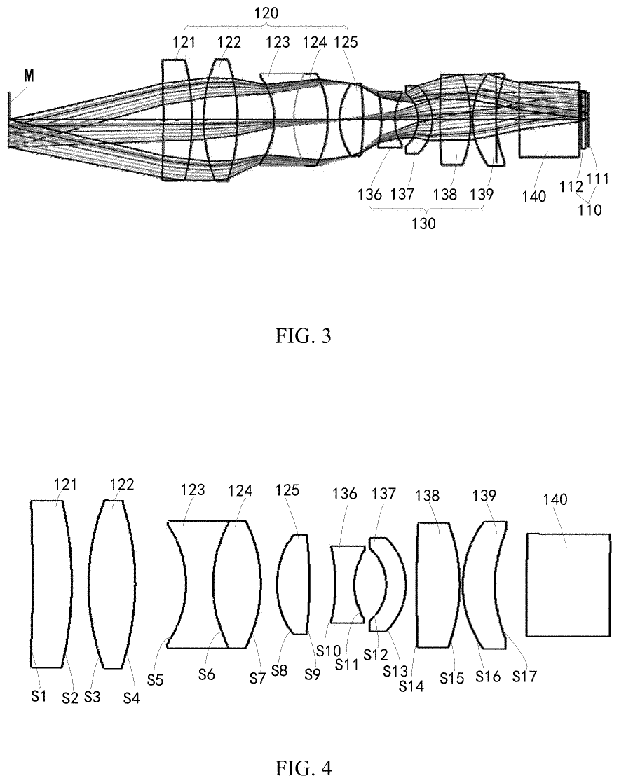

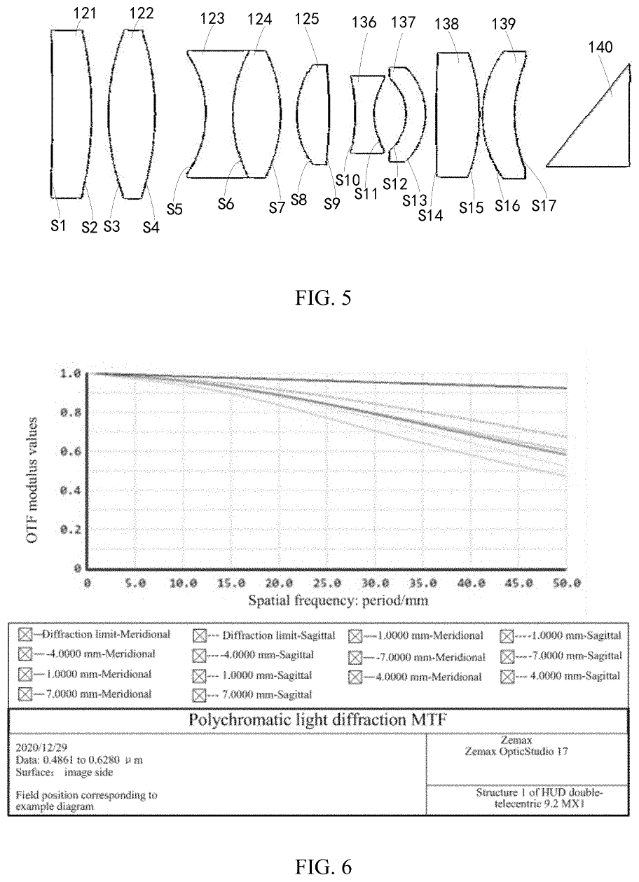

This embodiment of the present disclosure provides a double-telecentric projection lens, applicable to a projection optical system in a head-up display device mounted on an automobile. The head-up display device mounted on an automobile may be the head-up display device B of the automobile 1 as illustrated in the above application scenario. Referring to FIG. 3 and FIG. 4, an optical path and structure of the double-telecentric projection lens according to an embodiment of the present disclosure are illustrated. The double-telecentric projection lens 100 includes a front lens group 120, a rear lens group 130, and an equivalent prism 140 that are successively arranged between an image side M and a DMD chip 110.

The front lens group 120 includes a first lens 121, a second lens 122, a third lens 123, a fourth lens 124, and a fifth lens 125 that are successively arranged. The rear lens group 130 includes a sixth lens 136, a seventh lens 137, an eighth lens 138, and a ninth lens 139 that are successively arranged. The third lens 123 and the fourth lens 124 constitute a double-cemented lens. The double-cemented lens has good capabilities in correcting spherical aberration, chromatic aberration, and secondary spectrum. The DMD chip 110 is configured to simultaneously emit two images, wherein during simultaneous emission of the two images from the DMD chip 110, the simultaneously emitted two images are emitted from the double-telecentric projection lens 100 and imaged at different positions.

Specifically, the first lens 121, the second lens 122, the third lens 123, the fourth lens 124, the fifth lens 125, the sixth lens 136, the seventh lens 137, the eight lens 138, and the ninth lens 139 are all spherical lenses. An image side S1 of the first lens 121 is a concave surface, and an object side S2 of the first lens 121 is a convex surface; an image side S3 of the second lens 122 is a convex surface, and an object side S4 of the second lens 122 is a convex surface; an image side S5 of the third lens 123 is a concave surface, and an object side S6 of the third lens 123 is a concave surface; an image side S6 of the fourth lens 124 is a convex surface, and an object side S7 of the fourth lens 124 is a convex surface; an image side S8 of the fifth lens 125 is a convex surface, and an object side S9 of the fifth lens 125 is a convex surface; an image side S10 of the sixth lens 136 is a concave surface, and an object side S11 of the sixth lens 136 is a concave surface; an image side S12 of the seventh lens 137 is a concave surface, and an object side S13 of the seventh lens 137 is a convex surface; an image side S14 of the eighth lens 138 is a convex surface, and an object side S15 of the eight lens 138 is a convex surface; and an image side S16 of the ninth lens 139 is a convex surface, and an object side S17 of the ninth lens 139 is a concave surface. It should be noted that the object side S6 of the third lens 123 and the image side of the fourth lens 124 are two totally attached surfaces, which are herein marked as a same surface.

The function of the equivalent prism 140 is to deflect the light, and separate an illumination optical path from an imaging optical path to prevent interference. In some embodiments, the equivalent prism is a turning prism and a right-angle triangular prism, wherein one right-angle surface of the right-angle triangular prism is opposite to a light exit surface of the DMD chip 110, the other right-angle surface of the right-angle triangular prism is opposite to a light incident side of the rear lens group 130, and an inclined surface of the right-angle triangular prism has a reflection angle of 90 degrees; and

The DMD chip 110 includes an effective surface 111 of the DMD chip 110, and a protective glass 112 of the DMD chip 110. The DMD chip 110 is configured to emit the light beams for imaging. In an embodiment of the present disclosure, the DMD chip 110, as illustrated in FIG. 3, is divided into an upper region and a lower region, wherein the two regions are respectively configured to emit two light beams for imaging.

Specifically, as illustrated in Table 1, a group of actual design parameters of the double-telecentric projection lens 100 according to an embodiment of the present disclosure are illustrated. In the design parameters, a total optical length of the double-telecentric projection lens 100 according to an embodiment of the present disclosure may be controlled to be 150 mm, the double-telecentric projection lens 100 has an effective focal length of 90 mm, has a magnification of 1:1, and has a relative aperture of 2.

TABLE 1

| Minor serial | Radius of curvature | Thickness | Glass |
|---|---|---|---|
| number | (mm) | (mm) | material |
| S1 | −430 | 7 | H-ZLAF78B |
| S2 | −70 | 3 | |
| S3 | 43.2 | 8 | H-ZPK5 |
| S4 | −51 | 9 | |
| S5 | −20 | 5 | F13 |
| S6 | 26.0 | 9 | H-LAK4L |
| S7 | −22 | 3 | |
| S8 | 16.2 | 6 | N-FK51A |
| S9 | −82 | 5 | |
| S10 | −30 | 4 | H-ZBAF4 |
| S11 | 15 | 6 | |
| S12 | −9.0 | 4 | H-ZF52 |
| S13 | −12.0 | 2 | |
| S14 | 285.5 | 8 | H-LAK4L |
| S15 | −35 | 1 | |
| S16 | 23 | 6 | H-ZLAF78B |
| S17 | 28.3 | 0 | |

Based on the double-telecentric projection lens as illustrated in FIG. 3 and FIG. 4 and the actual design parameters of the double-telecentric projection lens as listed in Table 1, an imaging quality diagram of double-telecentric projection lens 100 in the full field and full wave-band as illustrated in FIG. 6 to FIG. 9 may be acquired. Specifically,

FIG. 6 is a schematic diagram of full field transfer function (MTF) values of the double-telecentric projection lens 100 according to an embodiment of the present disclosure. As illustrated in FIG. 6, the full field MTF of the double-telecentric projection lens 100 is controlled to be greater than 40%.

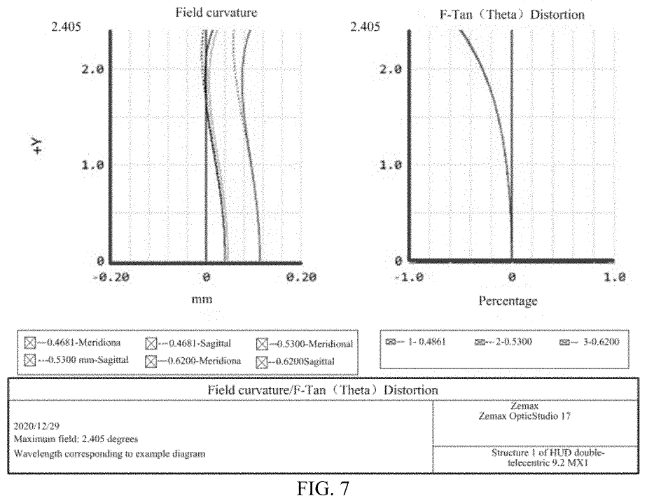

FIG. 7 is a schematic diagram of distortion and field curvature of a full field and full wave-band of the double-telecentric projection lens 100 according to an embodiment of the present disclosure, wherein the left part illustrates the field curvature, and the right part illustrates the distortion. As illustrated in FIG. 7, with respect to the double-telecentric projection lens 100, the field curvature is controlled to be less than 0.2 mm, and the distortion is controlled to be less than 0.5%.

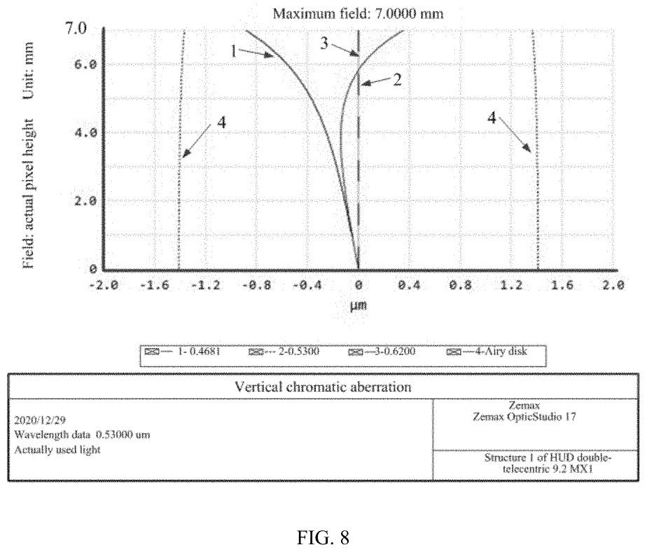

FIG. 8 is a schematic diagram of vertical chromatic aberration of a full field and full wave-band of the double-telecentric projection lens 100 according to an embodiment of the present disclosure. As illustrated in FIG. 8, the vertical chromatic aberration of the double-telecentric projection lens 100 is not greater than 1 μm.

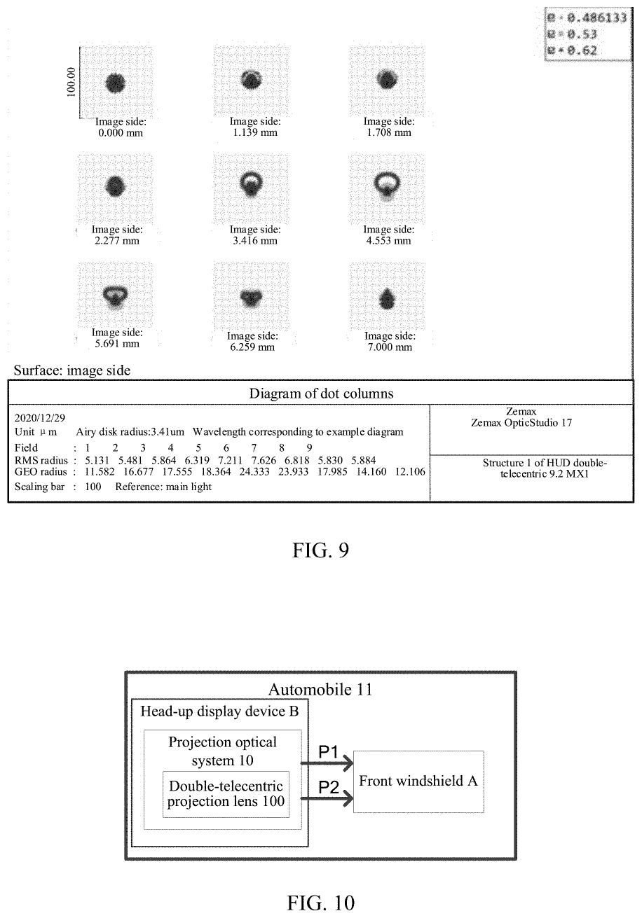

FIG. 9 is a schematic diagram of dot columns of a full field of the double-telecentric projection lens 100 according to an embodiment of the present disclosure. As illustrated in FIG. 8, a root mean square (RMS) radius of the double-telecentric projection lens 100 is controlled in the range of 5.0 μm<RMS<8 μm.

### Second Embodiment

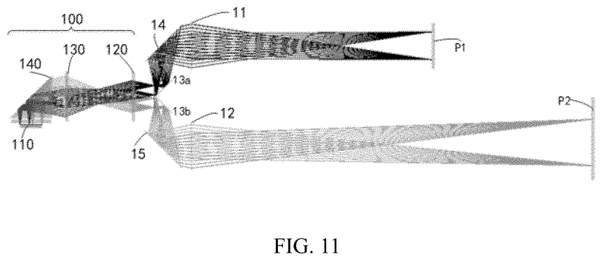

This embodiment of the present disclosure provides a head-up display device mounted on an automobile. The head-up display device mounted on an automobile may be the head-up display device B of the automobile 1 as illustrated in the above application scenario. Referring to FIG. 10 and FIG. 11, FIG. 10 illustrates a structure of a head-up display device mounted on an automobile according to an embodiment of the present disclosure, and FIG. 11 illustrates a structure of an optical path of a projection optical system in the head-up display device B of the automobile 1 in FIG. 10. The head-up display device B of the automobile 1 includes a projection optical system 10 capable of projecting a first image P1 and a second image P2 on a front windshield A of the automobile 1 such that imaging is achieved on the front windshield. The projection optical system 10 includes the double-telecentric projection lens 100 as described in the first embodiment, and a first lens 11, a second lens 12, a light splitting device 13, a first reflection unit 14, and a second reflection unit 15.

The double-telecentric projection lens 100 is the double-telecentric projection lens 100 as described in first embodiment. The structure, connection relationship, arrangement position, optical path, and the like of the double-telecentric projection lens 100 may refer to the specific description of the first embodiment, which is not described herein.

An optical center of the light splitting device 13 is arranged on an image side of the double-telecentric projection lens 100, and a light incident side of the light splitting device 13 is arranged to face a light exit side of the double-telecentric projection lens 100. Further, the light splitting device 13 includes a first reflection structure 13a and a second reflection structure 13b; wherein the first reflection structure 13a is configured to receive and reflect the light beam of the first image, the second reflection structure 13b is configured to receive and reflect the light beam of the second image, a light reflection side of the first reflection structure 13a is a first light reflection side of the light splitting device 13, and a light reflection side of the second reflection structure 13b is a second light reflection side of the light splitting device 13. Optionally, the first reflection structure 13a and the second reflection structure 13b are both a mirror; or the first reflection structure 13a and the second reflection structure 13b are both a combination of a mirror, and a filter, a highly reflective film and/or an anti-reflection lens.

A light incident side of the first reflection unit 14 is arranged to face a first light reflection side of the light splitting device 13. The first reflection unit 14 is a mirror arranged at a predetermined angle between the light splitting device 13 and the first lens 11. The first reflection unit 14 may also include a highly reflective film coated on the mirror to achieve total reflection of the light beams. In the embodiment as illustrated in FIG. 11 of the present disclosure, an inclined surface of the first reflection unit 14 has a reflection angle of 90 degrees. In some other configurations, the first reflection unit 14, and the angle thereof may be configured according to the actual needs, which are not limited to those in the embodiment of the present disclosure.

A light incident side of the first lens 11 is arranged to face a light reflection side of the first reflection unit 14, and a light exit side of the first lens 11 is configured to emit the first image. Specifically, the first lens 11 may be a single lens or a lens group composed of a plurality of lenses, and may also contain other optical instruments. In practical application scenarios, the first lens 11 may be configured according to the actual needs, which is not limited to that in the embodiment of the present disclosure.

A light incident side of the second reflection unit 15 is arranged to face a second light reflection side of the light splitting device 13. The second reflection unit 15 is a mirror arranged at a predetermined angle between the light splitting device 13 and the first lens 12. The second reflection unit 15 may also include a highly reflective film coated on the mirror to achieve total reflection of the light beams. In the embodiment as illustrated in FIG. 11 of the present disclosure, an inclined surface of the second reflection unit 15 has a reflection angle of 90 degrees. In some other configurations, the second reflection unit 15, and the angle thereof may be configured according to the actual needs, which are not limited to those in the embodiment of the present disclosure.

A light incident side of the second lens 12 is arranged to face a light reflection side of the second reflection unit 15, and a light exit side of the second lens 12 is configured to emit the second image. Specifically, the second lens 12 may be a single lens or a lens group composed of a plurality of lenses, and may also contain other optical instruments. In practical application scenarios, the second lens 12 may be configured according to the actual needs, which is not limited to that in the embodiment of the present disclosure.

The embodiments of the present disclosure provide a double-telecentric projection lens. The double-telecentric projection lens includes a front lens group, a rear lens group, and an equivalent prism that are successively arranged between an image side and a DMD chip; wherein the front lens group includes a first lens, a second lens, a third lens, a fourth lens, and a fifth lens that are successively arranged, and the rear lens group includes a sixth lens, a seventh lens, an eighth lens, and a ninth lens that are successively arranged, wherein the third lens and the fourth lens constitute a double-cemented lens; and the DMD chip is configured to simultaneously emit two images, wherein during simultaneous emission of the two images from the DMD chip, the simultaneously emitted two images are emitted from the double-telecentric projection lens and imaged at different positions. The double-telecentric projection lens according to the embodiments of the present disclosure is applicable to the projection optical system in the head-up display device mounted on an automobile such that simultaneous projection imaging of two pictures is achieved, and the imaging effect is good.

It should be noted that the above described device embodiments are merely for illustration purpose only. The units which are described as separate components may be physically separated or may be not physically separated, and the components which are illustrated as units may be or may not be physical units, that is, the components may be located in the same position or may be distributed into a plurality of network units. Part or all of the modules may be selected according to the actual needs to achieve the objects of the technical solutions of the embodiments.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A double-telecentric projection lens, applicable to a projection optical system in a head-up display device mounted on an automobile, the double-telecentric projection lens comprising a front lens group, a rear lens group, and an equivalent prism that are successively arranged between an image side and a DMD chip; wherein
the front lens group comprises a first lens, a second lens, a third lens, a fourth lens, and a fifth lens that are successively arranged, and the rear lens group comprises a sixth lens, a seventh lens, an eighth lens, and a ninth lens that are successively arranged, wherein the third lens and the fourth lens constitute a double-cemented lens; and
the DMD chip is configured to simultaneously emit two images, wherein during simultaneous emission of the two images from the DMD chip, the simultaneously emitted two images are emitted from the double-telecentric projection lens and imaged at different positions.

2. The double-telecentric projection lens according to claim 1, wherein
an image side of the first lens is a concave surface, and an object side of the first lens is a convex surface;
an image side of the second lens is a convex surface, and an object side of the second lens is a convex surface;
an image side of the third lens is a concave surface, and an object side of the third lens is a concave surface;
an image side of the fourth lens is a convex surface, and an object side of the fourth lens is a convex surface;
an image side of the fifth lens is a convex surface, and an object side of the fifth lens is a convex surface;
an image side of the sixth lens is a concave surface, and an object side of the sixth lens is a concave surface;
an image side of the seventh lens is a concave surface, and an object side of the seventh lens is a convex surface;
an image side of the eighth lens is a convex surface, and an object side of the eighth lens is a convex surface; and
an image side of the ninth lens is a convex surface, and an object side of the ninth lens is a concave surface.

3. The double-telecentric projection lens according to claim 2, wherein
the equivalent prism is a turning prism and a right-angle triangular prism, wherein one right-angle surface of the right-angle triangular prism is opposite to a light exit surface of the DMD chip, the other right-angle surface of the right-angle triangular prism is opposite to a light incident side of the rear lens group, and an inclined surface of the right-angle triangular prism has a reflection angle of 90 degrees; and
an optical axis of the DMD chip is perpendicular to an optical axis of the front lens group and the rear lens group.

4. The double-telecentric projection lens according to claim 3, wherein
the double-telecentric projection lens has a focal length of 90 mm, and the double-telecentric projection lens has a total length of 150 mm.

5. The double-telecentric projection lens according to claim 4, wherein
the double-telecentric projection lens has a magnification of 1:1, and the double-telecentric projection lens has a relative aperture of 2.

6. A head-up display device mounted on an automobile, comprising a projection optical system capable of projecting a first image and a second image on a front windshield of the automobile such that imaging is achieved on the front windshield, wherein the projection optical system comprises:
a double-telecentric projection lens, the double-telecentric projection lens is applicable to a projection optical system in a head-up display device mounted on an automobile, the double-telecentric projection lens comprising a front lens group, a rear lens group, and an equivalent prism that are successively arranged between an image side and a DMD chip; wherein
the front lens group comprises a first lens, a second lens, a third lens, a fourth lens, and a fifth lens that are successively arranged, and the rear lens group comprises a sixth lens, a seventh lens, an eighth lens, and a ninth lens that are successively arranged, wherein the third lens and the fourth lens constitute a double-cemented lens; and
the DMD chip is configured to simultaneously emit two images, wherein during simultaneous emission of the two images from the DMD chip, the simultaneously emitted two images are emitted from the double-telecentric projection lens and imaged at different positions; wherein
the double-telecentric projection lens is configured to simultaneously emit light beams of the first image and the second image; and
a light splitting device, wherein an optical center of the light splitting device is arranged on an image side of the double-telecentric projection lens, and a light incident side of the light splitting device is arranged to face a light exit side of the double-telecentric projection lens;
a first reflection unit, wherein a light incident side of the first reflection unit is arranged to face a first light reflection side of the light splitting device;
a first lens, wherein a light incident side of the first lens is arranged to face a light reflection side of the first reflection unit, and a light exit side of the first lens is configured to emit the first image;
a second reflection unit, wherein a light incident side of the second reflection unit is arranged to face a second light reflection side of the light splitting device; and
a second lens, wherein a light incident side of the second lens is arranged to face a light reflection side of the second reflection unit, and a light exit side of the second lens is configured to emit the second image.

7. The head-up display device according to claim 6, wherein
an image side of the first lens is a concave surface, and an object side of the first lens is a convex surface;
an image side of the second lens is a convex surface, and an object side of the second lens is a convex surface;
an image side of the third lens is a concave surface, and an object side of the third lens is a concave surface;
an image side of the fourth lens is a convex surface, and an object side of the fourth lens is a convex surface;
an image side of the fifth lens is a convex surface, and an object side of the fifth lens is a convex surface;
an image side of the sixth lens is a concave surface, and an object side of the sixth lens is a concave surface;
an image side of the seventh lens is a concave surface, and an object side of the seventh lens is a convex surface;
an image side of the eighth lens is a convex surface, and an object side of the eighth lens is a convex surface; and
an image side of the ninth lens is a convex surface, and an object side of the ninth lens is a concave surface.

8. The head-up display device according to claim 7, wherein
the equivalent prism is a turning prism and a right-angle triangular prism, wherein one right-angle surface of the right-angle triangular prism is opposite to a light exit surface of the DMD chip, the other right-angle surface of the right-angle triangular prism is opposite to a light incident side of the rear lens group, and an inclined surface of the right-angle triangular prism has a reflection angle of 90 degrees; and
an optical axis of the DMD chip is perpendicular to an optical axis of the front lens group and the rear lens group.

9. The head-up display device according to claim 8, wherein
the double-telecentric projection lens has a focal length of 90 mm, and the double-telecentric projection lens has a total length of 150 mm.

10. The head-up display device according to claim 9, wherein
the double-telecentric projection lens has a magnification of 1:1, and the double-telecentric projection lens has a relative aperture of 2.

11. The head-up display device according to claim 6, wherein
the light splitting device comprises a first reflection structure and a second reflection structure; wherein the first reflection structure is configured to receive and reflect the light beam of the first image, the second reflection structure is configured to receive and reflect the light beam of the second image, a light reflection side of the first reflection structure is the first light reflection side of the light splitting device, and a light reflection side of the second reflection structure is the second light reflection side of the light splitting device.

12. The head-up display device according to claim 11, wherein the first reflection structure and the second reflection structure are both a mirror.

13. The head-up display device according to claim 11, wherein the first reflection structure and the second reflection structure are both a combination of a mirror, and a filter, a highly reflective film and/or an anti-reflection lens.

14. The head-up display device according to claim 6, wherein the first reflection unit and the second reflection unit are both a mirror.

15. The head-up display device according to claim 7, wherein the first reflection unit and the second reflection unit are both a mirror.

16. The head-up display device according to claim 8, wherein the first reflection unit and the second reflection unit are both a mirror.

17. The head-up display device according to claim 9, wherein the first reflection unit and the second reflection unit are both a mirror.

18. The head-up display device according to claim 11, wherein the first reflection unit and the second reflection unit are both a mirror.

19. The head-up display device according to claim 12, wherein the first reflection unit and the second reflection unit are both a mirror.

20. The head-up display device according to claim 13, wherein the first reflection unit and the second reflection unit are both a mirror.
